(19) United States
(12) Patent Application Publication
(10) Pub. No.: US 2011/0280623 A1
(43) Pub. Date: Nov. 17, 2011

(54) Toner cartridge with waste toner storage and image forming apparatus having the same

(75) Inventors: Gun Heo, Yongin-si (KR); Se-il Kwon, Seoul (KR)

(73) Assignee: SAMSUNG ELECTRONICS CO., LTD., Suwon (KR)

(21) Appl. No.: 12/929,022

(22) Filed: Dec. 22, 2010

(30) Foreign Application Priority Data
May 11, 2010 (KR) 2010-0044089

(51) Int. Cl. G03G 15/08

(52) U.S. Cl. 399/120

(57) ABSTRACT

A toner cartridge for use in an image forming apparatus which includes a paper feeding unit, a developing unit, a transfer unit, and a fixing unit is provided. The toner cartridge may include a fresh toner storage to accommodate therein a fresh toner before use, a waste toner storage to accommodate therein a waste toner introduced through a waste toner inlet, and a waste toner moving device to move the waste toner introduced through the waste toner inlet of the waste toner storage away from the waste toner inlet. The waste toner storage may be arranged under the fresh toner storage in a manner in which an upper portion of the waste toner storage may be formed of a bottom of the toner storage.

### CROSS-REFERENCE TO RELATED APPLICATIONS

This application claims priority from Korean Patent Application No. 10-2010-0044089, filed on May 11, 2010, in the Korean Intellectual Property Office, the disclosure of which is incorporated herein by reference in its entirety.

### BACKGROUND

1. Field

Apparatuses consistent with the disclosure provided herein relate to an image forming apparatus, and more particularly, to a toner cartridge of an image forming apparatus.

2. Description of the Related Art

Image forming apparatuses, such as printers, facsimiles, copiers, or multi-function units (MFU), generally adopt the electrophotographic technology to form an image onto a print media. The image forming process may generally include electric charging, light exposing, image developing, image transferring, and image fixing. In the electric charging stage, a charging unit charges a photosensitive body to a predetermined level of electric potential. In the light exposing stage, a light emitting unit emits light onto the photosensitive body which is charged to the predetermined level of electric potential, to thus form an electrostatic latent image on the photosensitive body in accordance with print data. In the image developing stage, a developing unit supplies toner to the photosensitive body on which the electrostatic latent image is formed, to thus develop the latent image into a toner image. In the image transferring stage, a transfer unit transfers the toner image from the photosensitive body onto a print medium. In the image fixing stage, a fixing unit fixes the toner image onto the print medium, to thereby form a predetermined image into the print medium. The printing process is completed as the print medium is discharged outside the image forming apparatus.

In reality, toner cannot be entirely transferred from the surface of the photosensitive body onto the print medium. That is, a certain amount of toner remains on the surface of the photosensitive body after the image transferring stage. This remaining toner, or waste toner, causes uneven charging of the photosensitive body in the following electric charging stage, and frequently results in degradation of image quality. In order to resolve the problems associated with the waste toner, a waste toner removing unit is generally employed to remove the waste toner from the surface of the photosensitive body.

Since the waste toner is continuously generated as long as the image forming apparatus operates, it is necessary to employ a waste toner storage to accommodate the removed waste toner. This causes the size of the image forming apparatus to be rather bulky. Accordingly, it is necessary to employ a type of waste toner storage with which the size of an image forming apparatus can be minimized. Meanwhile, since the waste toner storage has a limited capacity, a user has to remove the collected waste toner from time to time, and it is a cumbersome process.

The waste toner storage generally has an inlet through which waste toner is introduced into the waste toner storage. However, due to the degraded flowability and easy solidification, the waste toner sometimes blocks the inlet of the waste toner storage. If this happens, the waste toner is not efficiently introduced into the waste toner storage, and the image forming apparatus does not operate normally. Accordingly, it is necessary to prevent the waste toner blockage of the waste toner storage inlet.

### SUMMARY

Exemplary embodiments of the present inventive concept overcome the above disadvantages and other disadvantages not described above. Also, the present inventive concept is not required to overcome the disadvantages described above, and an exemplary embodiment of the present inventive concept may not overcome any of the problems described above.

The present inventive concept provides a toner cartridge to which a waste toner storage is integrated, and an image forming apparatus having such toner cartridge.

The foregoing and/or other aspects are achieved by providing a toner cartridge for an image forming apparatus having a paper feeding unit, a developing unit, a transfer unit, and a fixing unit, may include a fresh toner storage to accommodate therein a fresh toner before use, a waste toner storage to accommodate therein a waste toner introduced through a waste toner inlet adjacent the waste toner storage, and a waste toner moving device to moving the waste toner introduced through the waste toner inlet of the waste toner storage away from the waste toner inlet. The waste toner storage may be arranged under the toner storage in a manner in which an upper portion of the waste toner storage is formed of a bottom of the fresh toner storage.

The toner cartridge may be engageable with the developing unit which receives a supply of the fresh toner from the fresh toner storage.

When the toner cartridge is mounted on the image forming apparatus, the waste toner storage may be arranged closer to the paper feeding unit than to the fixing unit.

The waste toner conveying device may include an auger having a rotational axis and a spiral portion attached to the rotational axis, and a partition enclosing the auger at least partially.

The auger may include a plate member which disperses the conveyed waste toner, and the partition may include a first opening at a location corresponding to that of the plate member.

The first opening of the partition may face a larger space of two spaces divided by the auger in the waste toner storage.

The partition may include a first side and a second side each being formed close to either side of the auger, and a bottom portion formed close to a lower portion of the auger.

The height of the second side may be lower than that of the first side.

The second side may be formed in a larger space between two spaces defined in the waste toner storage by the auger.

The height of at least a portion of the second side may decrease gradually away from the waste toner inlet.

The second side may be formed in a larger space of two spaces divided by the auger in the waste toner storage.

The second side may include one or more second openings.

The second side may be formed in a larger space of two spaces divided by the auger in the waste toner storage.

The plate member may have rigidity.

The plate member may have elasticity, and be interferable with the partition.

The foregoing and/or other aspects are achieved by providing an image forming apparatus may include a photosensitive body, a charging unit to charge the photosensitive body to a predetermined level of electric potential, a light emitting unit to emit light onto the photosensitive body to form an electrostatic latent image on the photosensitive body, a developing to develop the electrostatic latent image on the photosensitive body into a toner image, a toner cartridge having the above-described features of storing therein a fresh toner before use and supplying the fresh toner to the developing unit, a transfer unit to transfer the toner image from the photosensitive body onto a print medium, a waste toner removing unit to remove a waste toner remaining on the photosensitive body after the toner image is transferred onto the print medium, a waste toner conveying unit to convey the waste toner, removed by the waste toner removing unit, to a waste toner storage of the toner cartridge, and a fixing unit to fix the transferred toner image onto the print medium.

The waste toner storage of the toner cartridge may be arranged at an opposite side to the fixing unit with reference to the transfer unit.

The foregoing and/or other aspects are achieved by providing a waste toner storage for a toner cartridge of an image forming apparatus, the waste toner storage including: at least one space defined within the waste toner storage to receive a waste toner introduced through a waste toner inlet adjacent to the waste toner storage; and a waste toner moving device moving the waste toner introduced through the waste toner inlet away from the waste toner inlet and into the at least one space.

The waste toner moving device may include an auger having a rotational axis and a spiral portion attached to the rotational axis, and a partition at least partially enclosing the auger.

The toner cartridge may include a fresh toner storage to accommodate a fresh toner before use, the waste toner storage being arranged under the fresh toner storage within the toner cartridge.

### BRIEF DESCRIPTION OF THE DRAWINGS

The above and/or other aspects of the present inventive concept will be more apparent by describing certain exemplary embodiments of the present inventive concept with reference to the accompanying drawings, in which:

FIG. 1 is a schematic view of an image forming apparatus according to at least one embodiment;

FIG. 2 is a perspective view of a developing unit engaged with a toner cartridge;

FIG. 3 is a perspective view of a toner cartridge;

FIG. 4 is a perspective view of the toner cartridge of FIG. 3 from which a second side cover is removed;

FIG. 5 is a perspective view of the toner cartridge of FIG. 4 from which an upper casing and a first side cover are removed;

FIG. 6 is a partially cut perspective view of a toner cartridge;

FIG. 7 is a cross-sectional view taken on line I-I of FIG. 2;

FIG. 8 is a perspective view of a waste toner storage;

FIG. 9 is a partially-cut perspective view of a waste toner storage; and

FIGS. 10 to 13 illustrate a waste toner moving device according to various examples.

### DETAILED DESCRIPTION

Certain exemplary embodiments of the present inventive concept will now be described in greater detail with reference to the accompanying drawings.

In the following description, same drawing reference numerals are used for the same elements even in different drawings. The matters defined in the description, such as detailed construction and elements, are provided to assist in a comprehensive understanding of the present inventive concept. Accordingly, it is apparent that the exemplary embodiments of the present inventive concept can be carried out without those specifically defined matters. Also, well-known functions or constructions are not described in detail since they would obscure the invention with unnecessary detail.

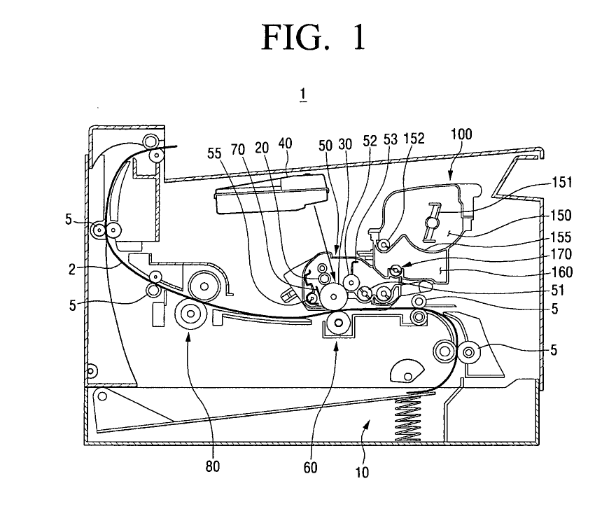

FIG. 1 schematically illustrates an image forming apparatus 1 according to at least one embodiment.

Referring to FIG. 1, the image forming apparatus 1 may be employed in various forms including, but not limited to, a printer, a facsimile, a copier, a multi-function unit (MFU) which operates to form a predetermined form of an image onto a print medium. A print medium is advanced along a passage 2.

A paper feeding unit 10 stores print media, such as paper, and feeds print media one at a time. The print medium may be conveyed by a plurality of conveying rollers 5 along the advancing passage 2.

A charging unit 20 charges a photosensitive body 30 to a predetermined level of electric potential. A light emitting unit 40 may emit a light onto the photosensitive body 30 to form an electrostatic latent image onto the photosensitive body 30 in accordance with print data.

A developing unit 50 develops the electrostatic latent image on the photosensitive body 30 into a toner image. The developing unit 50 may include a toner supply roller 51, a developing roller 52, and a regulating blade 53.

The toner supply roller 51 supplies toner to the developing roller 52. Accordingly, a layer of toner may be formed on the developing roller 52. The regulating blade 53 regulates the toner into a layer of constant thickness. The toner layer on the developing roller 52 is moved onto the electrostatic latent image formed on the photosensitive body 30 by the difference of electric potential, to thereby form a toner image.

A transfer unit 60 transfers the toner image developed on the photosensitive body 30 onto the print medium.

A waste toner removing unit 70 removes any remaining toner from the photosensitive body 30 after the transfer is completed.

A fixing unit 80 fixes the transferred toner image onto the print medium. The print medium, bearing the fixed toner image thereon, may then be discharged outside the image forming apparatus 1 by a plurality of conveying rollers 5.

A toner cartridge 100 stores therein fresh toner which is not used yet, and supplies the fresh toner to the developing unit 50 through a toner supply path (not illustrated).

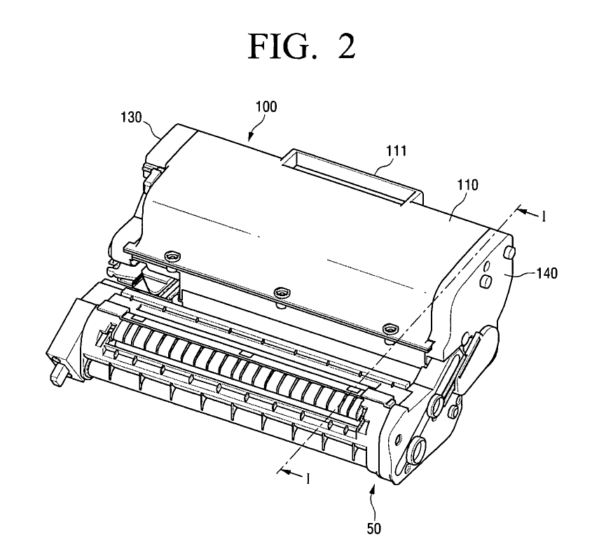

The toner cartridge 100 will be explained in greater detail below with reference to FIGS. 2 to 9.

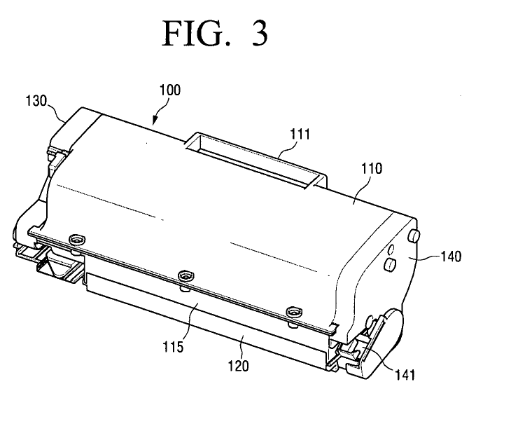

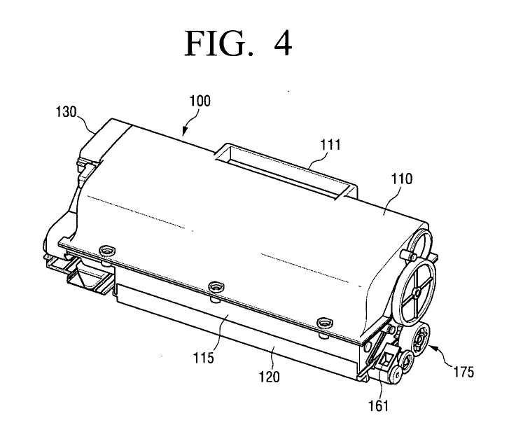

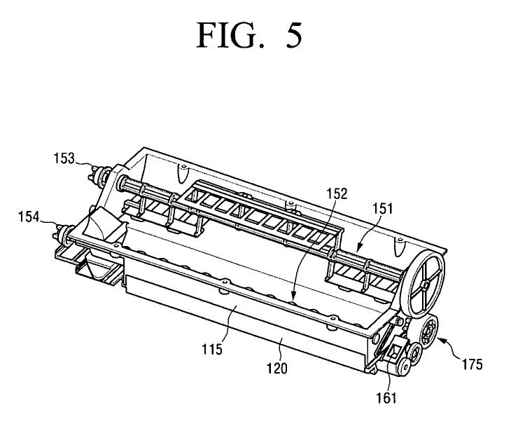

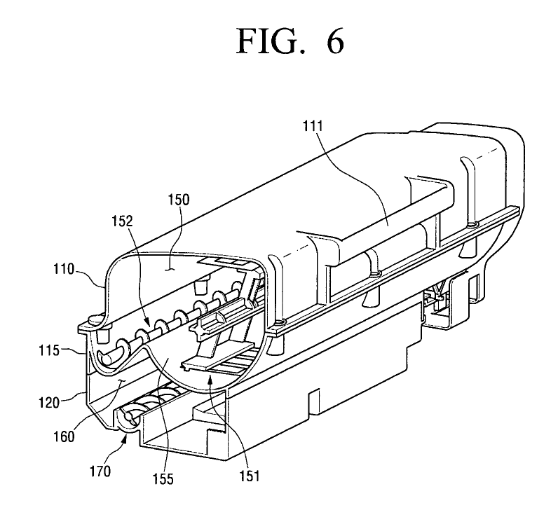

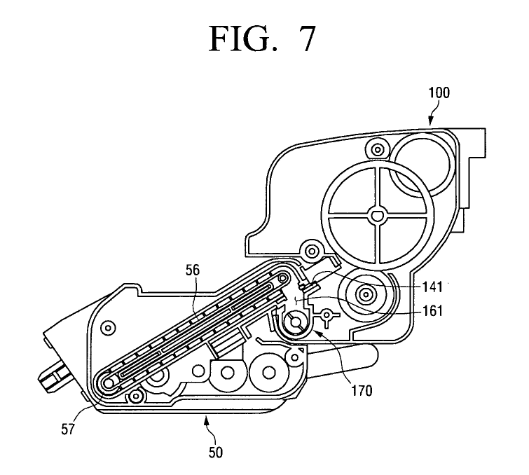

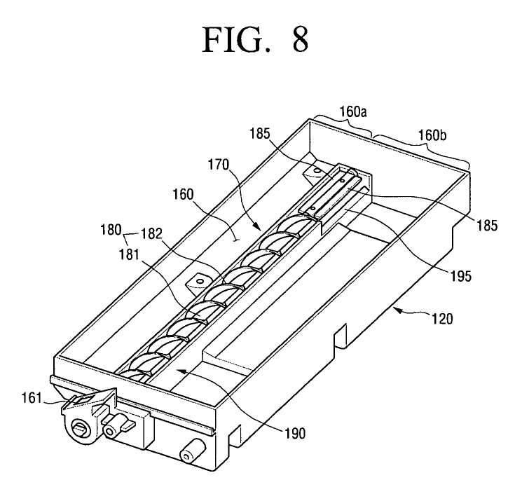

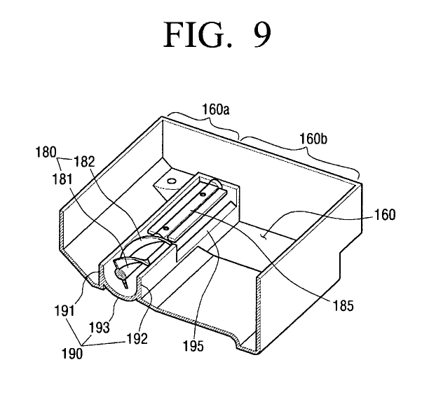

FIG. 2 is a perspective view of the developing unit 50 engaged with the toner cartridge 100, FIG. 3 is a perspective view of the toner cartridge 100, FIG. 4 is a perspective view of the toner cartridge 100 of FIG. 3 from which a second side cover 140 is removed, FIG. 5 is a perspective view of the toner cartridge 100 of FIG. 4 from which an upper casing 110 and a first side cover 130 are removed, FIG. 6 is a partially cut perspective view of the toner cartridge 100, FIG. 7 is a cross-section view taken on line I-I of FIG. 2, FIG. 8 is a perspective view of the waste toner storage 160, and FIG. 9 is a partially-cut perspective view of the waste toner storage 160.

The toner cartridge 100 may be a consumable component, and removable from the image forming apparatus 1. If the toner cartridge 100 runs out of the fresh toner completely, the toner cartridge 100 may be removed from the image forming apparatus 1, and a new toner cartridge 100 may be mounted in the image forming apparatus 1. If the toner cartridge 100 like the example illustrated in FIG. 3 is employed in the image forming apparatus 1, the toner cartridge 100 is engaged with the developing unit 50 as shown in FIG. 2. In such a situation, a toner supply path (not illustrated) may be open to allow the fresh toner of the toner cartridge 100 to be introduced into the developing unit 50.

Referring to FIGS. 3 and 6, the outer portion of the toner cartridge 100 may include an upper casing 110, a middle casing 115, a lower casing 120, a first side cover 130, and a second side cover 140. A handle 111 may be formed on the upper casing 110 for a user to grab, to thereby provide the user convenience during removal or installment of the toner cartridge 100.

In at least one embodiment, a fresh toner storage 150 may be formed between the upper casing 110 and the middle casing 115 to accommodate fresh toner therein, and a waste toner storage 160 may be formed between the middle casing 115 and the lower casing 120 to accommodate waste toner therein. In one embodiment, the waste toner storage 160 may be integrated with the toner cartridge 100. The first 130 and second side covers 140 may be attached to the sides of the upper casing 110, the middle casing 115 and the lower casing 120. However, the above are provided only for illustrative purposes, and other various examples are also possible. For example, as need demands, the toner cartridge 100 may include casing(s) other than the three casings (that is, upper, middle and lower casings 110, 115, 120), such as, one, two or more than three casings. In one embodiment, the first and second side covers 130 and 140 may be integrated with the toner cartridge 100.

As explained above, the fresh toner storage 150 accommodates therein fresh toner before use. A toner agitator 151 and a toner supply auger 152 may be arranged inside the fresh toner storage 150. The toner agitator 151 may agitate the toner accommodated in the fresh toner storage 150. The toner supply auger 152 may convey the toner of the fresh toner storage 150 toward a toner feeding path (not illustrated) so that the toner is introduced into the developing unit 50. Referring to FIG. 5, in order to drive the toner agitator 151 and the toner supply auger 152, a first coupler and a second coupler 153, 154 may be arranged on the first side of the toner cartridge 100. If the toner cartridge 100 is mounted on the image forming apparatus 1, a driving unit (not illustrated) of the image forming apparatus 1 may be engaged with the first and second couplers 153, 154, and as a result, the toner agitator 151 and the toner supply auger 152 are driven accordingly.

The waste toner storage 160 may accommodate the waste toner which is introduced through a waste toner inlet 161 (see FIGS. 4 and 8). Referring to FIG. 3, a shutter 141 may be provided on the second side cover 140 at a location corresponding to that of the waste toner inlet 161 to close the waste toner inlet 161. The shutter 141 may move to open the waste toner inlet 161, if the toner cartridge 100 is mounted on the image forming apparatus 1.

Referring to FIG. 1, the waste toner, removed from the photosensitive body 30 by the waste toner removing unit 70, may be conveyed to a direction of the waste toner inlet 161 (e.g., in a rightward direction in FIG. 2) by the auger 55 (see FIG. 1) formed inside the developing unit 50. After that, as shown in FIG. 7, a waste toner conveying belt 56 may convey the waste toner toward the waste toner inlet 161, so that the waste toner, removed by the waste toner removing unit 70, is introduced into the waste toner storage 160 of the toner cartridge 100. The waste toner conveying belt 56 may be driven by the driving roller 57 formed inside the developing unit 50. In one embodiment, the auger 55 and the waste toner conveying belt 56 may operate as a waste toner conveying unit to convey the waste toner, removed by the waste toner removing unit 70, to the waste toner storage 160 of the toner cartridge 100. However, the above are provided only for illustrative purposes, and other various examples are also possible. For example, examples other than the auger 55 or the waste toner conveying belt 56 may be employed as the waste toner conveying unit as long as these are able to convey the waste toner.

In one embodiment, the waste toner storage 160 may be arranged under the fresh toner storage 150. It is particularly desirable if a bottom 155 of the fresh toner storage 150 is formed of an upper side of the waste toner storage 160 as illustrated in FIGS. 1 and 6. By doing so, the waste toner storage 160 may be arranged immediately under the fresh toner storage 150, to thereby ensure maximum space of the waste toner storage 160 and at the same time, minimized size of the toner cartridge 100 and reduced material cost for the toner cartridge 100. Furthermore, the image forming apparatus 1 can be minimized accordingly.

If the waste toner storage 160 is arranged alongside the fresh toner storage 150 instead of underneath the fresh toner storage 150, the width of the toner cartridge 100 increases and the width of the image forming apparatus 1 increases. In other words, arranging the waste toner storage 160 and the fresh toner storage 150 side-by-side may not be efficient to minimize the image forming apparatus 1. Accordingly, the efficient minimization of the image forming apparatus 1 is possible by arranging the waste toner storage 160 under the fresh toner storage 150.

If the waste toner storage 160 is arranged above the fresh toner storage 150, a longer waste toner conveying belt 56 is needed to convey the waste toner from the developing unit 50 to the waste toner storage 160. In addition, the waste toner conveying belt 56 may have a high slope angle. As a result, more power is needed to drive the waste toner conveying belt 56, and the size of the developing unit 50 increases. The above problem can be solved by arranging the waste toner storage 160 under the fresh toner storage 150.

A waste toner moving device 170 moves the waste toner, introduced through the waste toner inlet 161 of the waste toner storage 160, away from the waste toner inlet 161 (see FIGS. 8 and 9). The waste toner moving device 170 may include an auger 180, and a partition 190 to enclose the auger 180 at least partially. The auger 180 may include a rotational axis 181 and a spiral portion 182 engaged with the rotating axis 181. Referring to FIG. 9, the partition 190 may include a first side 191, a second side 192, each being formed close to either side of the auger 180, and a bottom portion 193 formed closely below the auger 180.

If the waste toner is introduced through the waste toner inlet 161, the waste toner is conveyed along a lengthwise direction of the auger 180 by the auger 180. Herein, the efficiency of conveying waste toner may increase due to the partition 190 enclosing the auger 180. A predetermined space may be formed between the auger 180 and the partition 190 to prevent possible interference between the spiral portion 182 of the auger 180 and the partition 190 during the rotation of the auger 180.

A power to drive the auger 190 may be transmitted via a gear train 175 (see FIGS. 4 and 5). Therefore, in one embodiment, the driving unit (not illustrated) of the image forming apparatus 1 may drive not only the toner agitator 151, but also the auger 180 by using the gear train 175 which transmits power. However, the above embodiment is provided only for illustrative purposes, and other examples are also possible. For example, the auger 180 may be driven independently from the toner agitator 151.

A plate member 185 is formed on the auger 180 to disperse the conveyed waste toner. The plate member 185 may be made from a rigid material. The partition 190 includes a first opening 195 at a location corresponding to that of the plate member 185. After the waste toner is moved to the plate member 185, the waste toner is dispersed in a direction perpendicular to the direction of waste toner advancement due to the rotation of the plate member 185, and stored in the waste toner storage 160. Because the waste toner is dispersed by the plate member 185, solidification of waste toner is prevented, and it is easier for the waste toner to be filled into the waste toner storage 160.

In one embodiment, the waste toner may be dispersed more to a direction where the first opening 195 is formed. The waste toner storage 160 may be divided into a first space 160a and a second space 160b by the auger 180, and in at least one embodiment, the second space 160b may be larger than the first space 160a. Accordingly, it is desirable to form the first opening 195 to face the second space 160b. In one embodiment, the first opening 195 may be formed in the second side 192 of the partition 190. Although the first opening 195 is formed only in the second side 192 of the partition 190 in the embodiment explained above, it should be understood that the first opening 195 may also be formed in the first side 191 of the partition 190.

By the degraded flowability and increased tendency to solidify, the waste toner may block the waste toner inlet 161 of the waste toner storage 160. In one embodiment, the waste toner is moved away from the proximity of the waste toner inlet 161 by the waste toner moving device 170 and then stored, and this prevents the above-mentioned undesirable blockage of the waste toner inlet 161 by the waste toner.

Referring again to FIG. 1, if the toner cartridge 100 is mounted on the image forming apparatus 1, the waste toner storage 160 is at an opposite side to the fixing unit 80 with respect to the transfer unit 60. In other words, the waste toner storage 160 is arranged closer to the feeding unit 10 than to the fixing unit 80. A lot of heat is generated while the toner image transferred by the transfer unit 60 is fixed into the print medium. For example, the temperature around the fixing unit 80 may increase up to 180° C. or 190° C. and the high temperature accelerates the solidification of the waste toner. In one embodiment, the waste toner storage 60 is arranged away from the proximity of the fixing unit 80, and accordingly, solidification of the waste toner in the waste toner storage 160 due to high temperature is prevented.

In one embodiment, the waste toner may be conveyed only by the auger 180 and the partition 190. Accordingly, the waste toner moving device 170 may have a simple structure, the number of parts may be minimized, the assembling process may be simplified, and the manufacture cost may be reduced.

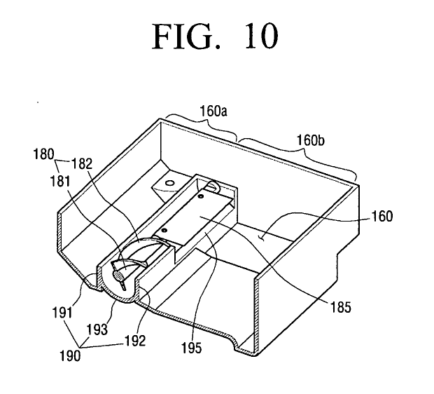

FIGS. 10 to 12 illustrate modifications of the waste toner moving device 170 according to other examples. The like elements will be given the same reference numerals and detailed explanations of any overlapping components will be omitted for the sake of brevity.

In the example illustrated in FIG. 10, the plate member 185 formed on the auger 180 may be made from an elastic material. The size of the elastic plate member 185 may be determined to a degree that may cause interference with a predetermined portion of the partition 190. Accordingly, as the plate member 185 in rotation breaks free from interference with the partition 190, vibration is generated along the plate member 185, causing more efficient dispersion of the waste toner.

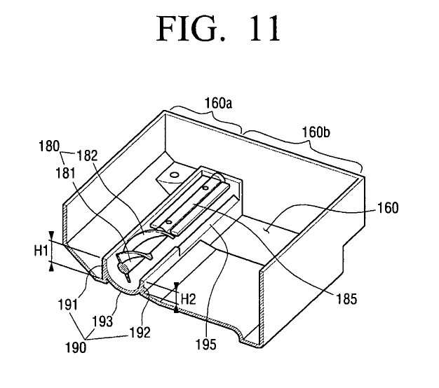

In the example illustrated in FIG. 11, the second side 192 of the partition 190 has a smaller height H2 than the height H1 of the first side 191. Accordingly, some of the waste toner conveyed along the auger 180 may move over the second side 192 and to the second space 160b of the waste toner storage 160. As a result, since the auger 180 is responsible for conveying less waste toner, less power is needed to drive the auger 180 and the waste toner is stored in the waste toner storage 160 relatively evenly.

As explained above, the second side 192 has the reduced height H2, and this is in consideration of the sizes of the first and second spaces 160a, 160b of the waste toner storage 160. That is, since the second space 160b is larger than the first space 160a, the height of the second side 192, which is closer to the second space 160b containing higher amount of waste toner, is reduced. In another embodiment, the first space 160a may be formed larger than the second space 160b and the first side 191 may have a lower height than that of the second side 192.

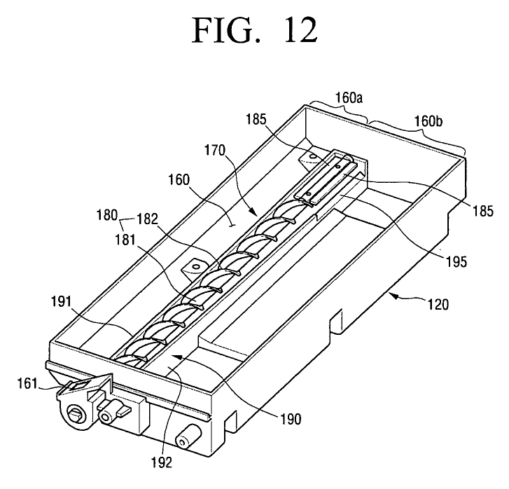

In the embodiment illustrated in FIG. 12, the height of the second side 192 of the partition 190 gradually decreases away from the waste toner inlet 161. Accordingly, some of the waste toner conveyed along the auger 180 may move over the second side 192 and to the second space 160b of the waste toner storage 160. As a result, since the auger 180 is responsible for conveying less waste toner, less power is needed to drive the auger 180 and the waste toner is stored in the waste toner storage 160 relatively evenly.

By forming the second side 192 to have a gradually decreasing height from the waste toner inlet 161, the blockage of the waste toner inlet 161 by the pile of waste toner located close to the waste toner inlet 161 is prevented.

Furthermore, the second side 192, and not the first side 191, is formed to have the varying height, and this is in consideration of the sizes of the first and second spaces 160a, 160b of the waste toner storage 160, as mentioned above. In another embodiment, the first space 160a may be larger than the second space 160b, and the first side 191 may have the varying height.

Although the example illustrated in FIG. 12 has the generally varying height across the entire part of the second side 192, in another embodiment, only a predetermined portion of the second side 192 may have the varying height. For example, the gradually-decreasing height may appear a predetermined distance away from the waste toner inlet 161.

Furthermore, although the embodiment of FIG. 12 illustrates the first side 191 with the constant height and the second side 192 with the varying height, in another embodiment, both the first and second sides 191, 192 may have varying heights.

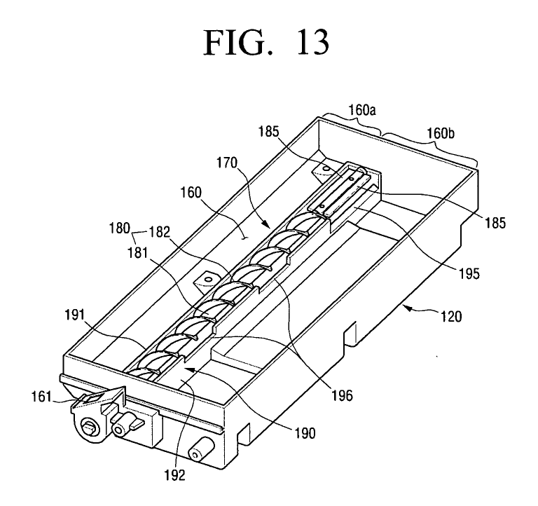

In the embodiment illustrated in FIG. 13, the second side 192 of the partition 190 may include one or more second openings 196. Accordingly, some of the waste toner conveyed along the auger 180 may move to the second space 160b of the waste toner storage 160 through the one or more second openings 196. As a result, since the auger 180 is responsible for conveying less waste toner, less power is needed to drive the auger 180, and the waste toner is stored in the waste toner storage 160 relatively evenly.

Herein, the second side 192, and not the first side 191, has the one or more second openings 196, and this is in consideration of the sizes of the first and second spaces 160a, 160b of the waste toner storage 160, as mentioned above. In another embodiment, the first space 160a may be larger than the second space 160b, and the first side 191 may have one or more second openings 196.

Although only the second side 192 has the one or more second openings 196 in the embodiment of FIG. 13, in another embodiment, both the first and second sides 191, 192 may have one or more second openings 196 respectively.

The partition 190 may still have various other modifications in addition to the embodiments illustrated in FIGS. 11 to 13. For example, in the second partition 192 of FIG. 12, one or more second openings 196 may be formed. That is, the structures of the partition 190 illustrated in the examples of FIGS. 11 to 13 may be adequately combined with each other and employed.

The capacity of the waste toner storage 160 may be determined in accordance with the amount of fresh toner accommodated in the fresh toner storage 150 and the efficiency of transfer. For example, if the amount of fresh toner is 440 g and the efficiency of transfer is 80%, the amount of waste toner is, in theory, 88 g (i.e., 440 g×0.8). Thus, the waste toner storage 150 has to have a capacity to accommodate at least 88 g of waste toner. In this case, the waste toner storage 150 is able to contain all the generated waste toner until the fresh toner is used up completely. If the fresh toner is used up and a new toner cartridge 100 is mounted in place, the waste toner storage of the new toner cartridge 1 starts receiving the waste toner. Therefore, since the waste toner storage 150 is integrated with the toner cartridge 100, there is no user inconvenience of having to frequently remove the waste toner.

In the embodiments explained above, the toner cartridge 100 is a separate component from the developing unit 50. In another embodiment, the toner cartridge 100 may be formed integrally with the developing unit 50 and therefore, used as one single cartridge. It is clear that the present inventive concept applies equally to this another embodiment.

The foregoing exemplary embodiments and advantages are merely exemplary and are not to be construed as limiting the present invention. The present teaching can be readily applied to other types of apparatuses. Also, the description of the exemplary embodiments of the present inventive concept is intended to be illustrative, and not to limit the scope of the claims, and many alternatives, modifications, and variations will be apparent to those skilled in the art.

What is claimed is:

1. A toner cartridge for an image forming apparatus having a paper feeding unit, a developing unit, a transfer unit, and a fixing unit, the toner cartridge comprising:
a fresh toner storage to accommodate therein a fresh toner before use;
a waste toner storage to accommodate therein a waste toner introduced through a waste toner inlet adjacent the waste toner storage; and
a waste toner moving device moving the waste toner introduced through the waste toner inlet of the waste toner storage away from the waste toner inlet,
wherein the waste toner storage is arranged under the fresh toner storage, an upper portion of the waste toner storage being formed of a bottom of the fresh toner storage.

2. The toner cartridge according to claim 1, wherein the toner cartridge is engageable with the developing unit which receives a supply of the fresh toner from the fresh toner storage.

3. The toner cartridge according to claim 1, wherein the waste toner storage is arranged closer to the paper feeding unit than to the fixing unit when the toner cartridge is mounted in the image forming apparatus.

4. The toner cartridge according to claim 1, wherein the waste toner moving device comprises an auger having a rotational axis and a spiral portion attached to the rotational axis, and a partition at least partially enclosing the auger.

5. The toner cartridge according to claim 4, wherein the auger comprises a plate member which disperses the conveyed waste toner, the partition having a first opening at a location corresponding to that of the plate member.

6. The toner cartridge according to claim 5, wherein the first opening of the partition faces a larger space of two spaces divided by the auger in the waste toner storage.

7. The toner cartridge according to claim 5, wherein the plate member has rigidity.

8. The toner cartridge according to claim 5, wherein the plate member has elasticity, and is interferable with the partition.

9. The toner cartridge according to claim 4, wherein the partition comprises a first side and a second side each being formed close to either side of the auger, and a bottom portion formed close to a lower portion of the auger.

10. The toner cartridge according to claim 9, wherein a height of the second side is lower than a height of the first side.

11. The toner cartridge according to claim 10, wherein the second side is formed in a larger space of two spaces divided by the auger in the waste toner storage.

12. The toner cartridge according to claim 9, wherein a height of at least a portion of the second side decreases gradually away from the waste toner inlet.

13. The toner cartridge according to claim 12, wherein the second side is formed in a larger space of two spaces divided by the auger in the waste toner storage.

14. The toner cartridge according to claim 9, wherein the second side comprises one or more second openings.

15. The toner cartridge according to claim 14, wherein the second side is formed in a larger space of two spaces divided by the auger in the waste toner storage.

16. An image forming apparatus, comprising:
a photosensitive body;
a charging unit to charge the photosensitive body to a predetermined level of electric potential;
a light emitting unit to emit light onto the photosensitive body to form an electrostatic latent image on the photosensitive body;
a developing to develop the electrostatic latent image on the photosensitive body into a toner image;
a toner cartridge to store therein a fresh toner before use and supply the fresh toner to the developing unit;
a transfer unit to transfer the toner image from the photosensitive body onto a print medium;
a waste toner removing unit to remove a waste toner remaining on the photosensitive body after the toner image is transferred onto the print medium;
a waste toner conveying unit to convey the waste toner, removed by the waste toner removing unit, to a waste toner storage of the toner cartridge; and
a fixing unit to fix the transferred toner image onto the print medium,
wherein the toner cartridge comprises:
a fresh toner storage accommodating therein a fresh toner before use,
a waste toner storage accommodating therein the waste toner introduced through a waste toner inlet adjacent the waste toner storage from the waste toner conveying unit, the waste toner storage being arranged under the fresh toner storage, an upper portion of the water toner storage being formed of a bottom of the fresh toner storage, and
a waste toner moving device moving the waste toner introduced through the waste toner inlet of the waste toner storage away from the waste toner inlet.

17. The image forming apparatus according to claim 16, wherein the waste toner storage of the toner cartridge is arranged at an opposite side to the fixing unit with respect to the transfer unit.
